(19) United States
(12) Patent Application Publication
(10) Pub. No.: US 2018/0038303 A1
(43) Pub. Date: Feb. 8, 2018

(54) METHOD OF SWITCHING FROM A PRESSURIZED TO NON-PRESSURIZED FUEL SYSTEM WHEN AN EVAPORATIVE EMISSIONS LEAK IS DETECTED

(71) Applicant: Eaton Corporation, Cleveland, OH (US)

(72) Inventor: Matthew Memmer, Plymouth, MI (US)

(73) Assignee: Eaton Corporation, Cleveland, OH (US)

(21) Appl. No.: 15/716,823

(22) Filed: Sep. 27, 2017

Related U.S. Application Data
(63) Continuation of application No. PCT/US2016/024147, filed on Mar. 25, 2016.
(60) Provisional application No. 62/139,071, filed on Mar. 27, 2015.

(51) Int. Cl. F02D 41/22; F02D 41/00; F02M 25/08

(52) U.S. Cl. CPC F02D 41/22; F02M 25/0836; F02M 25/0818; F02M 25/089; F02D 41/003; F02D 2041/225

(57) ABSTRACT

A method of operating a fuel tank system in a non-hybrid vehicle is provided. The fuel tank system has a fuel tank, a carbon canister, a canister vent valve, a vapor management valve and an isolation valve fluidly connected between the fuel tank and the carbon canister. The fuel tank system is operated in a pressurized mode wherein the fuel tank is pressurized and the isolation valve is closed. The method determines whether a leak has been detected. The fuel tank system is operated in a non-pressurized mode based on the leak being detected.

### CROSS-REFERENCE TO RELATED APPLICATIONS

This application is a continuation of International Application No. PCT/US2016/024147 filed Mar. 25, 2016, which claims priority to U.S. Provisional Application No. 62/139,071 filed on Mar. 27, 2015, which is incorporated by reference in its entirety as if set forth herein.

### FIELD

The present disclosure relates generally to fuel tanks on passenger vehicles and more particularly to pressurized fuel system on a non-hybrid powertrain vehicle that switches to a non-pressurized configuration upon detection of a leak.

### BACKGROUND

Proper venting and handling of fuel and fuel vapor is required for fuel tanks. More particularly, fuel tanks must be properly vented for passenger motor vehicles. Furthermore, fuel tanks must properly account for containment of liquid fuel. In addition, fuel tank systems must minimize the amount of hydrocarbons released into the atmosphere. Fuel tank vapor and emission control systems may be used to control the flow of fuel vapors from the vehicle's fuel tank and also to control the relative pressure of the fuel tank. Fuel tanks may generate fuel vapors during various operating phases and these vapors may be directed to a carbon canister or other component responsible for storing them. These vapors can then be regularly purged to the engine where they are burned during combustion.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of operating a fuel tank system in a non-hybrid vehicle is provided. The fuel tank system has a fuel tank, a carbon canister, a canister vent valve, a vapor management valve and an isolation valve fluidly connected between the fuel tank and the carbon canister. The fuel tank system is operated in a pressurized mode wherein the fuel tank is pressurized and the isolation valve is closed. The method determines whether a leak has been detected. The fuel tank system is operated in a non-pressurized mode based on the leak being detected.

According to additional features, operating the fuel tank system in the non-pressurized mode includes opening the isolation valve based on a leak being detected. Operating the fuel tank system in the non-pressurized mode can further include opening the canister vent valve permitting vapor to flow out of the carbon canister and through the canister vent valve. Operating the fuel tank system in the non-pressurized mode can further include opening the vapor management valve permitting vapor the flow out of the carbon canister and through the vapor management valve to an engine. Operating the fuel tank system in the non-pressurized mode can further include illuminating a malfunction indicator lamp.

In other features, operating the fuel tank system in the non-pressurized mode can further include changing an engine boost profile to allow for purging of the carbon canister. Operating the fuel tank system in a pressurized mode can include operating the fuel tank with a pressure greater than zero. Operating the fuel tank system according to other features can include operating the fuel tank with a pressure less than zero. Operating the fuel tank system in a non-pressurized mode can include operating the fuel tank with a pressure of zero.

A method of operating a fuel tank system in a non-hybrid vehicle according to additional features is provided. The fuel tank system has a fuel tank, a carbon canister, a canister vent valve, a vapor management valve and an isolation valve fluidly connected between the fuel tank and the carbon canister. The fuel tank system is operated in a pressurized mode wherein the fuel tank is pressurized and the isolation valve is closed. The method determines whether a leak has been detected. The isolation valve is opened based on a leak being detected. Vapor is permitted to flow out of the carbon canister and through (i) the canister vent valve to atmosphere and (ii) the vapor management valve to an internal combustion engine.

According to additional features, opening the isolation valve includes operating the fuel tank system in a non-pressurized mode. Operating the fuel tank system in the non-pressurized mode further includes illuminating a malfunction indicator lamp. Operating the fuel tank system in the non-pressurized mode further includes changing an engine boost profile to allow for purging of the carbon canister. Operating the fuel tank system in a pressurized mode can include operating the fuel tank with a pressure greater than zero. Operating the fuel tank system according to other features can include operating the fuel tank with a pressure less than zero. Operating the fuel tank system in a non-pressurized mode can include operating the fuel tank with a pressure of zero.

A fuel tank system configured to operate in a normally pressurized mode and a non-pressurized mode upon detection of a leak is provided. The fuel tank system includes a fuel tank, a carbon canister, a canister vent valve, a vapor management valve and an isolation valve. The canister vent valve can be fluidly connected between the fuel tank and the carbon canister. The canister vent valve can be movable between a closed and an open position. The vapor management valve can be fluidly connected between the carbon canister and an engine and is movable between a closed and an open position. The isolation valve can be fluidly connected between the fuel tank and the carbon canister and movable between a closed and an open position. The isolation valve is moved from the closed position to the open position based on a leak being detected. Vapor is permitted to flow out of the carbon canister and through (i) the canister vent valve to atmosphere and through (ii) the vapor management valve to an internal combustion engine.

According to other features, the fuel tank system can further comprise a malfunction indicator lamp. The malfunction indicator lamp can be configured to be illuminated upon a leak being detected. The fuel tank system can be configured to change an engine boost profile based on a leak being detected to allow for purging of the carbon canister. The fuel tank system can be configured to operate in the pressurized mode until the leak is detected whereupon the fuel tank system is configured to operate in the non-pressurized mode.

### BRIEF DESCRIPTION OF THE DRAWINGS

The present disclosure will become more fully understood from the detailed description and the accompanying drawings, wherein:

FIG. 1 is a schematic illustration of an on-board diagnostic system and engine control module configured for use with a pressurized fuel tank system according to the present disclosure;

FIG. 2 is a schematic illustration of a pressurized fuel tank system constructed in accordance to one example of the present disclosure and shown in a pressurized mode;

FIG. 3 is a schematic illustration of the pressurized fuel tank system of FIG. 1 and shown during leak detection where the fuel tank system is sealed and a pressure sensor on the fuel tank monitors for a change in pressure;

FIG. 4 is a schematic illustration of the pressurized fuel tank system of FIG. 2 and shown subsequent to a leak detected and the pressurized fuel tank system operating in a non-pressurized mode; and

FIG. 5 shows an exemplary method of switching from a pressurized to a non-pressurized fuel system when an evaporative emissions leak is detected according to one example of the present disclosure.

### DETAILED DESCRIPTION

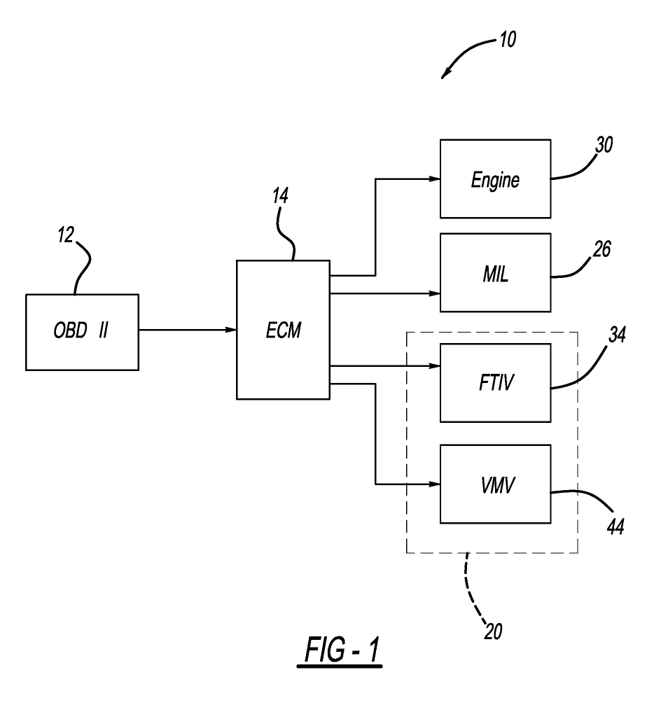

With initial reference to FIG. 1, an evaporative emissions system constructed in accordance to one example of the present disclosure is shown and generally identified at reference numeral 10. The evaporative emissions system 10 includes an on board diagnostic (OBD-II) system 12 that communicates with an engine control module (ECM) 14 according to one example of the present disclosure. The OBD-II system 12 provides input to the ECM 14 including a signal indicative of the presence of a leak in a fuel tank system 20. As will become appreciated from the following discussion, the evaporative emissions system 10 is configured to change operation from a pressurized mode to a non-pressurized mode upon detection of a leak. The evaporative emissions system 10 can be configured to further send a signal to a malfunction indicator lamp (MIL) 26 indicative of a leak detected. The evaporative emissions system 10 can further communicate with an engine 30 to change the boost profile upon detection of a leak.

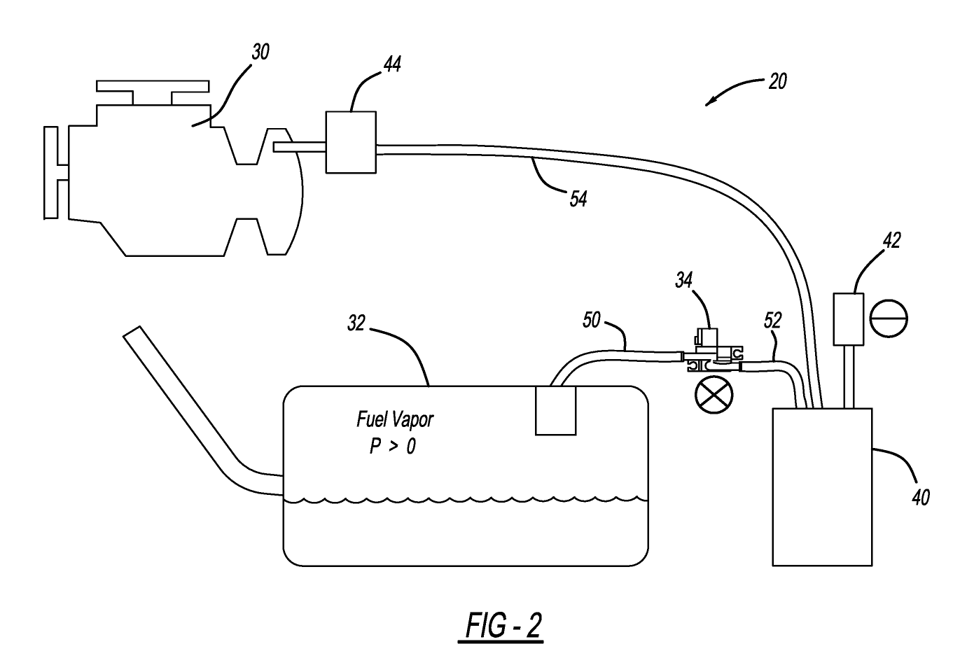

With continued reference to FIG. 1 and additional reference to FIG. 2, the fuel tank system 20 will be described in greater detail. The fuel tank system 20 includes a fuel tank 32, a fuel tank isolation valve (FTIV) 34, a carbon canister 40, a canister vent valve 42 and a vapor management valve (VMV) 44. The fuel tank system 20 is configured to operate under normal conditions in a pressurized mode.

A first vapor line 50 is connected between the fuel tank 32 and the FTIV 34. A second vapor line 52 is connected between the FTIV 34 and the carbon canister 40. A third vapor line 54 is connected between the carbon canister 40 and the vapor management valve 44. In the pressurized mode, the fuel tank 32 has a pressure greater than zero. In the pressurized mode, the FTIV 34 is closed sealing the fuel tank 32 and holding pressure generated from liquid fuel evaporation. The engine 30 can be on or off. The canister vent valve 42 is open. The vapor management valve 44 may be open or closed.

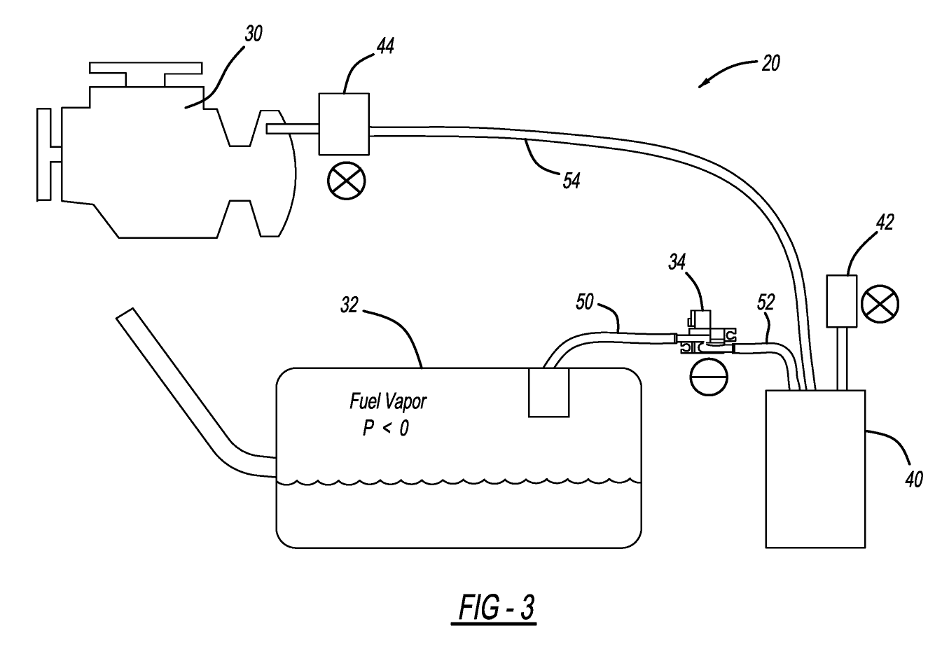

Turning now to FIG. 3, the fuel tank system 20 is shown operating during normal leak detection mode. In leak detection mode the fuel tank system 20 is sealed and a pressure sensor on the fuel tank 32 monitors for a change in pressure. In one example, the FTIV 34 can monitor pressure in the fuel tank 32. In other examples another dedicated pressure sensor may be incorporated. During leak detection mode, the FTIV 34 is open and fuel vapor can flow through the first vapor line 50, through the FTIV 34, through the second vapor line 52 and into the carbon canister 40. The canister vent valve 42 is closed and the vapor management valve 44 is closed.

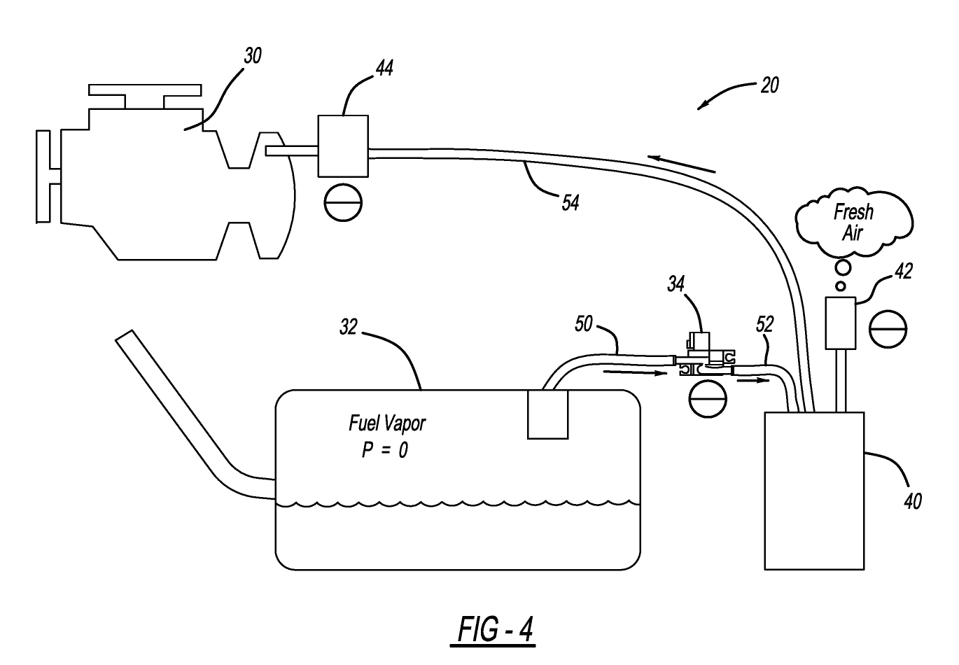

Turning now to FIG. 4, the fuel tank system 20 is shown subsequent to a leak detected. Once a leak is detected, the fuel tank system 20 changes operation of the fuel tank system 20 from a pressurized system to a non-pressurized fuel system. If a leak is detected by the OBD-II system 12, the ECM 14 sends a signal indicative to illuminate the MIL 26. The ECM 14 further communicates with the engine 30 to operate in a purge mode. In a purge mode, vapor flow is permitted to run through the third vapor line 54, through the open vapor management valve 44 and into the engine 30. The engine 30 can subsequently burn the vapors.

In the non-pressurized mode, the FTIV 34 is open allowing vapor to flow through the first vapor line 50 and through the second vapor line 52 into the carbon canister 40. Vapor is further permitted to flow from the carbon canister 40 to the engine 30 where it is burned during combustion as described above. The fuel tank system 20 operates in a non-pressurized mode until the leak is repaired. In the non-pressurized mode, there is no loss of vehicle operation and the risk of hydrocarbons escaping the fuel tank system 20 is minimized. Once the leak has been repaired, the evaporative emissions system 10 returns to operate in a pressurized mode.

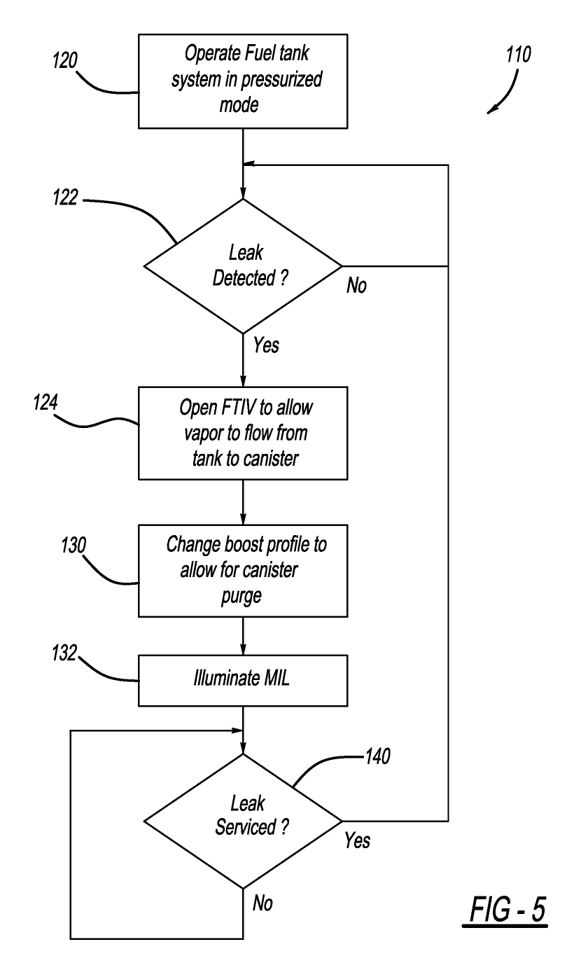

With reference now to FIG. 5, an exemplary method of switching from a pressurized to a non-pressurized fuel system when an evaporative emissions leak is detected according to one example of the present disclosure is shown and generally identified at reference numeral 110. The evaporative emissions system 10 operates the fuel tank system 20 in a pressurized mode in block 120. In the pressurized mode (see also FIG. 2), the FTIV 34 is closed and the canister vent valve 42 is open. In other configurations (FIG. 3), the fuel tank can be operated in leak detection mode where the fuel tank system 20 is sealed. In the leak detection mode the pressure in the fuel tank 32 can be less than zero (vacuum). In block 122 the evaporative emissions system 10 determines if a leak in the fuel tank system 20 has been detected.

If no leaks are detected, control loops to block 122. If a leak has been detected, the fuel tank system 20 changes operation to the non-pressurized mode (see also FIG. 4). In the non-pressurized mode, the FTIV 34 is opened to allow for vapor to flow from the fuel tank 32 to the carbon canister 40. The canister vent valve 42 and the vapor management valve 44 are opened. In block 130 the boost profile of the engine is changed to allow for purging of the carbon canister 40. In block 132 the MIL 26 is illuminated. In 140, the evaporative emissions system 10 determines if the leak in the fuel system 20 has been serviced or repaired. If a leak has been repaired, control loops to block 122. If the leak has not been repaired, control loops to block 140.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A method of operating a fuel tank system in a non-hybrid vehicle, the fuel tank system having a fuel tank, a carbon canister, a canister vent valve, a vapor management valve and an isolation valve fluidly connected between the fuel tank and the carbon canister, the method comprising:
operating the fuel tank system in a pressurized mode wherein a fuel tank of the fuel tank system is pressurized and the isolation valve is closed;
determining whether a leak has been detected; and
operating the fuel tank system in a non-pressurized mode based on the leak being detected.

2. The method of claim 1 wherein operating the fuel tank system in the non-pressurized mode comprises:
opening the isolation valve based on a leak being detected.

3. The method of claim 2 wherein operating the fuel tank system in the non-pressurized mode comprises:
opening the canister vent valve permitting vapor to flow out of the carbon canister and through the canister vent valve.

4. The method of claim 3 wherein operating the fuel tank system in the non-pressurized mode comprises:
opening the vapor management valve wherein vapor is permitted to flow out of the carbon canister and through the vapor management valve to an engine.

5. The method of claim 2 wherein operating the fuel tank system in the non-pressurized mode further includes illuminating a malfunction indicator lamp.

6. The method of claim 2 wherein operating the fuel tank system in the non-pressurized mode further includes changing an engine boost profile to allow for purging of the carbon canister.

7. The method of claim 1 wherein operating the fuel tank system in a pressurized mode includes operating the fuel tank with a pressure greater than zero.

8. The method of claim 1 wherein operating the fuel tank system in a pressurized mode includes operating the fuel tank with a pressure less than zero.

9. The method of claim 1 wherein operating the fuel tank system in a non-pressurized mode includes operating the fuel tank with a pressure of zero.

10. A method of operating a fuel tank system in a non-hybrid vehicle, the fuel tank system having a fuel tank, a carbon canister, a canister vent valve, a vapor management valve and an isolation valve fluidly connected between the fuel tank and the carbon canister, the method comprising:
operating the fuel tank system in a pressurized mode wherein a fuel tank of the fuel tank system is pressurized and the isolation valve is closed;
determining whether a leak has been detected; and
opening the isolation valve based on a leak being detected, wherein vapor is permitted to flow out of the carbon canister and through (i) the canister vent valve to atmosphere and (ii) the vapor management valve to an internal combustion engine.

11. The method of claim 10 wherein opening the isolation valve includes operating the fuel tank system in a non-pressurized mode, wherein operating the fuel tank system in the non-pressurized mode further includes illuminating a malfunction indicator lamp.

12. The method of claim 11 wherein operating the fuel tank system in the non-pressurized mode further includes changing an engine boost profile to allow for purging of the carbon canister.

13. The method of claim 11 wherein operating the fuel tank system in a pressurized mode includes operating the fuel tank with a pressure greater than zero.

14. The method of claim 11 wherein operating the fuel tank system in a pressurized mode includes operating the fuel tank with a pressure less than zero.

15. The method of claim 11 wherein operating the fuel tank system in a non-pressurized mode includes operating the fuel tank with a pressure of zero.

16. A fuel tank system for a non-hybrid vehicle configured to operate in a normally pressurized mode and a non-pressurized mode upon detection of a leak, the fuel tank system comprising:
a fuel tank;
a carbon canister;
a canister vent valve fluidly connected between the fuel tank and the carbon canister, the canister vent valve movable between a closed and an open position;
a vapor management valve fluidly connected between the carbon canister and an engine and movable between a closed and an open position; and
an isolation valve fluidly connected between the fuel tank and the carbon canister and movable between a closed and an open position;
wherein the isolation valve is moved from the closed position to the open position based on a leak being detected, wherein vapor is permitted to flow out of the carbon canister and through (i) the canister vent valve to atmosphere and (ii) the vapor management valve to an internal combustion engine.

17. The fuel tank system of claim 16, wherein the fuel tank system further comprises a malfunction indicator lamp and wherein the malfunction indicator lamp is configured to be illuminated upon a leak being detected.

18. The fuel tank of claim 16 wherein the fuel tank system is configured to change an engine boost profile based on a leak being detected to allow for purging of the carbon canister.

19. The fuel tank of claim 16 wherein the fuel tank system is configured to operate in the pressurized mode until the leak is detected whereupon the fuel tank system is configured to operate in the non-pressurized mode.

20. The fuel tank of claim 19 wherein (a) the pressurized mode includes a fuel tank with one of a pressure greater than zero and a pressure less than zero; (b) the non-pressurized mode includes operating the fuel tank with a pressure of zero.
